(19) United States
(12) Patent Application Publication
(10) Pub. No.: US 2010/0097413 A1
(43) Pub. Date: Apr. 22, 2010

(54) PLASMA DISPLAY DEVICE, AND DRIVING METHOD USED IN THE PLASMA DISPLAY DEVICE

(76) Inventor: Yukihiro Matsumoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/450,550

(22) PCT Filed: Mar. 30, 2007
(86) PCT No.: PCT/JP2007/057311

§ 371 Date: Dec. 7, 2009

(51) Int. Cl. G09G 5/10

(52) U.S. Cl. 345/691; 345/63

(57) ABSTRACT

[Problem] A plasma display device is provided which is capable of reducing an afterimage (burning) in a short time.

[Means to solve the problem] At start time of first afterimage reduction driving mode, the number of times of discharge corresponds to first driving power, then gradually to second driving power and, at its termination time, the number of times of discharge corresponds to the second driving power, then gradually, to the first driving power. At start time of third afterimage reduction driving mode, power to be supplied to each region changes from the first driving power gradually to the fourth driving power and, at its termination time, the driving power changes from the first driving power to the fourth driving power and, at its termination, the driving power changes from the fourth driving power gradually to the first driving power. At start time of second afterimage reduction mode, the number of times of discharge corresponds to the first driving power, then gradually to the third driving power.

### TECHNICAL FIELD

The present invention relates to a plasma display device and a driving method to be used for the plasma display device and more particularly to the plasma display device and its driving method capable of reducing an afterimage (burning) occurring when a fixed image is displayed for a long time or display of a fixed image is iterated on a plasma display panel.

### BACKGROUND TECHNOLOGY

Following two types of afterimages occurring in a plasma display device are known.

(1) First Afterimage

For example, as shown in FIG. 1(a), after a bright image portion is locally displayed on a screen of the plasma display device, as shown in FIG. 1(b), a bright image is displayed on the entire screen with same brightness as in FIG. 1(a), the discharged portion (bright portion) is seen as a more excessively bright image and is still left as an afterimage. This is a phenomenon in which, due to existence of priming charged particles in the portion where discharge has occurred in cells, compared with the portion where no discharge has occurred, portions in cells where the discharge had occurred are seen as excessively bright images. This phenomenon occurs because the number of sustaining pulses decreases rapidly when a partially bright image (having low APL [Average Picture Level]) changes to a totally bright image (having high APL). This phenomenon is here called a “first afterimage”.

(2) Second afterimage

When a fixed image such as a still image is displayed for a long time or consecutively on a screen of the plasma display device, difference in the progress of deterioration of fluorescent substance among discharged cells or not discharged cells occurs which causes the burning. Moreover, if an image having an aspect ratio of 4:3 is displayed only in a central portion of a screen of the plasma display device having an aspect ratio of 16:9 and, if black display is maintained on both sides of the screen, no discharge occurs in the cells on both the sides, difference occurs in the progress of deterioration of fluorescent substance between the central portion of the screen and portions on both the sides, which also causes the burning. This kind of afterimage caused by the difference in the deterioration of fluorescent substances is here called a “second afterimage”. The second afterimage occurs due to a long use of the display device and the occurrence of the afterimage can be suppressed, however, the afterimage having once occurred can not be reduced in a short period of time.

As a countermeasure against the above first afterimage, for example, one technology is disclosed in Patent Reference 1. In the method for reducing afterimages in a PDP disclosed in the Patent Reference 1, APL of an inputted image is calculated by an APL calculating section and, based on a curve of the number of sustaining pulses for the APL having a section of a triangular function or a section of a linear function, the number of sustaining pulses corresponding to the APL is computed. Then, the PDP is driven by a driving section based on the number of sustaining pulses. This method intends to reduce afterimages by preventing a rapid change in a curve of the number of sustaining pulses for the APL. Moreover, as a countermeasure against the above second afterimage, a method is proposed in which, like in an Orbiter mode to slowly move an entire image on a displayed screen, by preventing display of same cells for an accumulated long period of time, by dispersing cells whose fluorescent substance is deteriorated, or by lowering display luminance, the afterimage is reduced.

Patent Reference 1: Japanese Patent Application Laid-open No. 2005-128544 (Abstract, FIGS. 4 and 5).

### DISCLOSURE OF THE INVENTION

### Problems to be Solved by the Invention

However, the conventional plasma display device has following problems to be solved. That is, the countermeasure disclosed in the Patent Reference 1 against the first afterimage has a disadvantage in that it takes much time to reduce afterimages. Another example of the problem is that the disclosed countermeasure against the second afterimage is partially employed and provides some effects, however, to reduce, in a comprehensive manner, the first and second afterimages, no further proposal has been made. Therefore, to reduce the first and second afterimages totally still remains unsolved.

### Means for Solving Problem

In order to solve the above problems, the invention stated in Claim 1 relates to a plasma display device characterized by including a plasma display panel, an afterimage judging section to measure continuous time of an image having correlation being not smaller than specified to be displayed on a display screen of the plasma display panel, and a driving unit having a first afterimage reduction driving mode to drive display following termination of the first fixed display, when termination of first fixed display is detected in which the continuous time of an image is longer than first time and is shorter than second time being longer than the first time, by supplying second driving power being larger than first driving power corresponding to a normal display mode to the plasma display panel.

Also, the invention described in Claim 6 relates to a plasma display device characterized by a plasma display panel providing a plurality of display colors, an afterimage judging section to divide a display screen of the plasma display panel into a plurality of regions and to detect correlation of a display image signal corresponding to each display color to be displayed in each of the regions and to measure continuous time of display in each of the regions having correlation being larger than specified to at least any one of display colors, and a driving unit having a first afterimage reduction driving mode to drive display following the termination of the first fixed display, when the termination of first fixed display is detected in which the continuous time of an image is longer than first time and is shorter than second time being longer than the first time, by supplying second driving power being larger than first driving power corresponding to a normal display mode to the plasma display panel.

Also, the invention described in Claim 9 relates to a method of driving a plasma display device characterized by a step of measuring continuous time of an image having correlation being larger than specified to be displayed on a display screen of the plasma display panel, and a step of driving display following the termination of the fixed display, when second fixed display is detected in which the continuous time of an image is longer than the second time, by supplying second driving power being larger than first driving power corresponding to a normal display mode to the plasma display panel.

Also, the invention described in Claim 10 relates to a method of driving a plasma display device characterized by a step of detecting correlation of a display screen signal corresponding to each display color to be displayed in each of the regions obtained by dividing a display screen of a plasma display panel into a plurality of regions, a step of measuring an average picture level of the display image signal, and a step of driving display in each of the regions following the termination of the first fixed display by applying second driving power being larger than first driving power corresponding to a normal display mode when second fixed display is detected in which the continuous time of any one of display colors is longer than the second time and when average picture level of the display colors is more than specified value.

### BRIEF DESCRIPTION OF DRAWINGS

FIG. 1 is a diagram explaining a first afterimage occurring on a plasma display panel.

FIG. 2 is a block diagram showing electrical configurations of main components of a plasma display device according to a first embodiment of the present invention.

FIG. 3 is a diagram illustrating main components of a display section of FIG. 2.

FIG. 4 is a diagram showing a method of gray-level display to be used for the plasma display panel of FIG. 3.

FIG. 5 is a schematic diagram showing a state in which a display image of the display section is divided into a plurality of regions.

FIGS. 6(a) and 6(b) are time charts explaining operations of a luminance control section.

FIG. 7 is a block diagram showing electrical configurations of main components making up the plasma display device according to a second embodiment of the present invention.

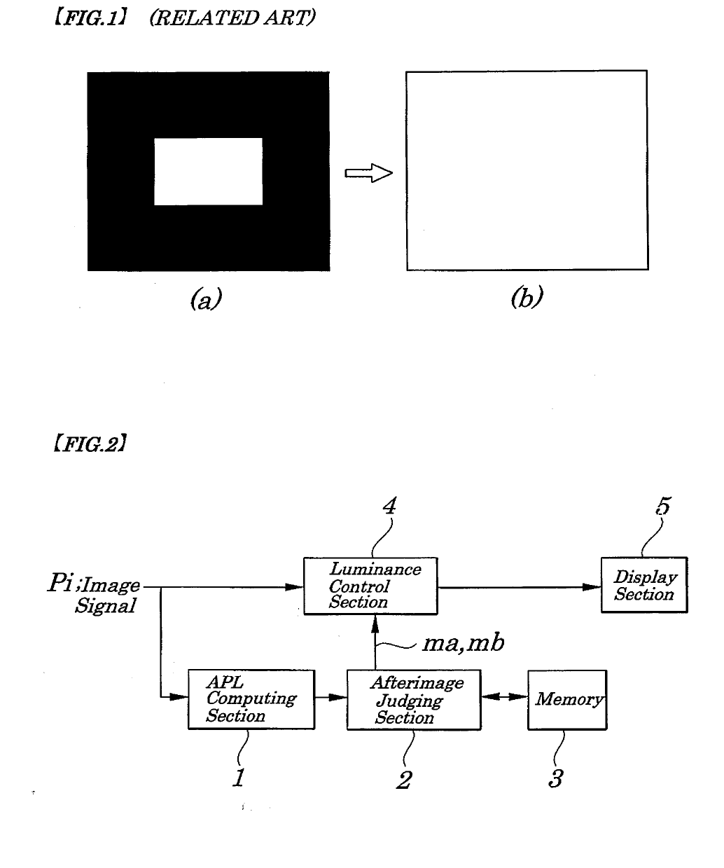

### EXPLANATION OF CHARACTERS

1: APL computing section (part of driving unit)

2: Afterimage judging section (part of driving unit)

3: Memory (part of driving unit)

4: Luminance control section (part of driving unit)

5: Display section (PDP, plasma display panel)

11: Glass substrate (part of PDP)

12: Surface discharge electrode pair (part of PDP)

13: Dielectric layer (part of PDP)

14: Black matrix (part of PDP)

15: Glass substrate (part of PDP)

16: Data electrode (part of PDP)

17: White glaze layer (part of PDP)

18: Rib (part of PDP)

19: Fluorescent substance

21: Correlation computing section (part of driving unit)

SF1, SF2, . . . , SF8: Subfield

### BEST MODE OF CARRYING OUT THE INVENTION

While display is in a first afterimage reduction driving mode, second driving power being smaller than a first driving power corresponding to a normal display mode is applied by a driving unit to a plasma display panel for driving the same, which progresses the activation of discharge space, thus enabling a first afterimage to be reduced in a short period of time, whereas, while the display is in a second afterimage reduction driving mode, third power being smaller than the first driving power is supplied to the plasma display panel for driving the same, whereby a second afterimage on the plasma display panel can be reduced.

Continuous time of images having correlation among others being stronger than specified to be displayed on the plasma display panel device is measured by an afterimage judging section. The luminance control section acting also as a driving unit judges that a first fixed display is detected when the continuous time of images having correlation being stronger than specified continues for a period of time longer than a first time and for a period of time shorter than a second time being longer than the first time and when the termination of the continuous time of images is detected for a period of time shorter than the second time. During display following the termination of the first fixed display, the plasma display panel is driven by the operation in the first afterimage reduction driving mode. In the first afterimage reduction driving mode, the plasma display panel is driven by the second driving power being larger than the first driving power corresponding to a normal display mode and, therefore, the afterimage (first afterimage) existing after the termination of the first fixed display can be rapidly reduced.

Moreover, the luminance control section judges that the second fixed display is detected when having detected the persistence of images having correlation being stronger than designated for a longer period of time than the second time. To perform the second fixed display, the plasma display panel is driven by the operation in the second image reduction driving mode. In the second afterimage reduction driving mode, the plasma display panel is driven by third driving power being less than the first driving power corresponding to the normal display mode and, therefore, the occurrence of the afterimage (second afterimage) caused by the second fixed display can be suppressed. In the process of detection of the first and second afterimages, first, any one of display colors assigned to a specified region making up part of the display screen is detected as first fixed display and second fixed display represented by the corresponding color, which allows the specified region to be judged respectively as the first or second fixed display. Moreover, when any one of colors in the specified region is detected as the first fixed display and second fixed display, a condition for the detection, for example, the condition that an average signal level of the display colors in the region is higher than specified may be added. If the average signal level of the display colors is lower than specified, in general, it is the case where the first afterimage and second afterimage are both unconspicuos.

### FIRST EMBODIMENT

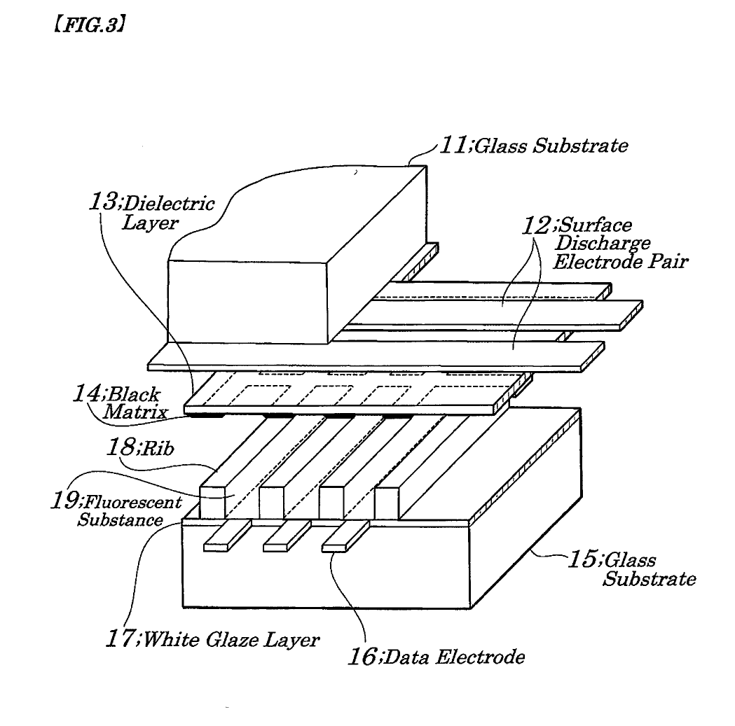

FIG. 2 is a block diagram showing electrical configurations of main components of a plasma display device according to a first embodiment of the present invention. The plasma display device of the first embodiment 1, as shown in FIG. 2, includes an APL computing section 1, an afterimage judging section 2, memory 3, a luminance control section 4, and a display section 5. The display section 5 is made up of a PDP. The PDP includes a plurality of surface discharge electrodes pairs, each made up of a scanning electrode and discharge sustaining electrode and disposed in parallel to each other with a discharge gap interposed therebetween, a plurality of data electrodes each intersecting the surface discharge electrodes, and a plurality of display cells each formed at the intersection between the surface discharge electrode and data electrode. The luminance control section 4 operates the PDP panel in the first afterimage reduction driving mode in which second driving power being larger than the first driving power corresponding to a normal display mode is supplied to the PDP of the display section 5 for driving the same and in the second afterimage reduction driving mode in which third power being small than the first driving power is supplied for driving the same. In the first and second afterimage reduction driving modes, in addition to normal display image, all white images, white and black checkered images, and inverted images of the normal display image are displayed as the afterimage reduction images.

The APL computing section 1 divides a display image on the display section 5 into a plurality of regions based on an image signal pi and computes the APL of R (red), G (green), and B (blue) for every region in every specific time (for example, 10 sec.). The afterimage judging section 2 sends out the APL of R, G, and B computed by the APL computing section 1 to the memory 3 so as to be stored therein and, when a first fixed time is detected during which a change of the APL of at least one of the R, G, and B is lower than specified and continuous time during which the APL value is higher than designated is longer than the first time and not longer than second time being longer than the first time, transmits a first mode control signal ma to the luminance control section 4 and, when a second fixed time is detected during which the continuous time is longer than the above time, transmits a second control signal mb to the luminance control section 4. In this case, the luminance control section 4 performs operations in the first afterimage reduction driving mode according to the first mode control signal ma and in the second afterimage reduction driving mode according to the second mode control signal mb.

Further, the luminance control section 4 detects the termination of the first fixed display for each region and applies the first afterimage reduction driving mode to the region for a specific period of time after the termination of the first fixed display. When the termination of the first fixed display for a first color is detected and the termination of the second fixed display for other colors is not detected, the first afterimage reduction driving mode is applied for a specific period of time after the termination of the first fixed display to all colors in the region. However, if the second fixed display for any of colors is detected during the operations in the first afterimage reduction mode, the second afterimage reduction driving mode is applied to all colors in the region. When the first and second afterimages overlap, priority is given to operations in the second afterimage and the second afterimage reduction driving mode is applied. Moreover, the luminance control section 4 detects the second fixed display for every region and, while the second fixed display continues for the region, the second afterimage reduction driving mode is applied. When the second fixed display for the first color is detected and the second fixed display for other colors is not detected, the second afterimage reduction driving mode is applied to all colors in the region.

The luminance control section 4 line-sequentially applies a scanning pulse during one frame period on a display screen to be displayed by a display cell of a PDP of the display section 5 and simultaneously sets one or more address discharge periods during which the above address discharge is allowed to occur on the display cell selected by applying a display data pulse being synchronous with a scanning pulse to each data electrode and also sets one or more discharge sustaining periods during which address discharge is allowed to occur on each display cell by alternately applying a discharge sustaining pulse to the above each discharge sustaining electrode and the above each scanning electrode and, in the first afterimage reduction driving mode, the number of times of discharge of the discharge sustaining pulse per unit time is made to correspond to the above second driving power and, in the second afterimage reduction driving mode, the number of times of discharge per unit time of the above discharge sustaining pulse is made to correspond to the above third driving power. In the example in particular, the luminance control section 4 divides one frame period for a display screen to be gray-level displayed by a display cell of a PDP in the display section 5 to a plurality of subfields obtained by assigning weights based on a gray level and sets the above address discharge period and discharge sustaining period on each subfield.

Moreover, the luminance control section 4, at the start time of the first afterimage reduction driving mode, the number of times of discharge per unit time of the discharge sustaining pulse is made to correspond to the first driving power, then gradually to the above second driving power and, at the termination time of the first afterimage reduction driving mode, the number of times of discharge is made to correspond to the first driving power, then gradually to the above third driving power and, at the same time, the number of times of discharge is allowed to correspond to the third driving power, then gradually to the first driving power. In this case, the luminance control section 4, in the first afterimage reduction driving mode, by increasing the frequency of a discharge sustaining pulse relative to a frequency at the normal display mode, makes the number of times of discharge correspond to the second driving power and, in the second afterimage reduction driving mode, by decreasing the frequency of the discharge sustaining pulse relative to a frequency at the normal display mode, makes the number of times of discharge to the third driving power. When the frequency of the discharge sustaining pulse is increased or decreased, at the time of the normal display mode, a frequency of about 400 Hz is used and, in the first afterimage reduction driving mode, a frequency of about 600 Hz is used, and, in the second afterimage reduction driving mode, a frequency of about 200 Hz is used.

In addition, the luminance control section 4 provides a third afterimage reduction driving mode in which a third driving power being larger than the above first driving power and being smaller than the second driving power is supplied to a region adjacent to the region detected as the above fixed display and a fourth afterimage reduction driving mode in which a fourth driving power being smaller than the third driving power and larger than the above third driving power is supplied to a region adjacent to the region detected as the above second fixed display. The luminance control section 4, at the start of the above third afterimage reduction driving mode, gradually changes power to be supplied to the region from the above first driving power to the above fourth driving power and, at the termination of the above third afterimage reduction driving mode, gradually changes from the fourth driving power to the second driving power, while, at the start time of the above fourth afterimage reduction driving mode, gradually changes the power to be applied to the region from the above first driving power to the above fifth driving power. The above APL computing section 1, afterimage judging section 2, memory 3, and luminance control section 4 make up a driving unit.

FIG. 3 is a diagram illustrating configurations of main components of the display section in FIG. 2. The display section 5, as shown in FIG. 3, includes surface discharge electrode pairs 12 each made up of a transparent conductive film on which unillustrated metal bus electrodes are stacked in layer, a dielectric layer 14 to a surface of which a magnesium oxide film are adhered, and a black lattice-shaped matrix 14 which determines a pixel, all formed on a glass substrate 11 serving as a display side. On the glass substrate 15 formed on a rear side are formed a data electrode 16, a white glaze layer 17, and a stripe-like rib 18 and, in a groove surrounded by the rib 18, each fluorescent substance 19 emitting fluorescent light of three primary colors (R, G, and B) is painted with each other. Between the glass substrates 11 an 15 is hermetically sealed discharge gas. At each of the intersection regions between the surface discharge electrode pair 12 and data electrode 16, a display cell is formed.

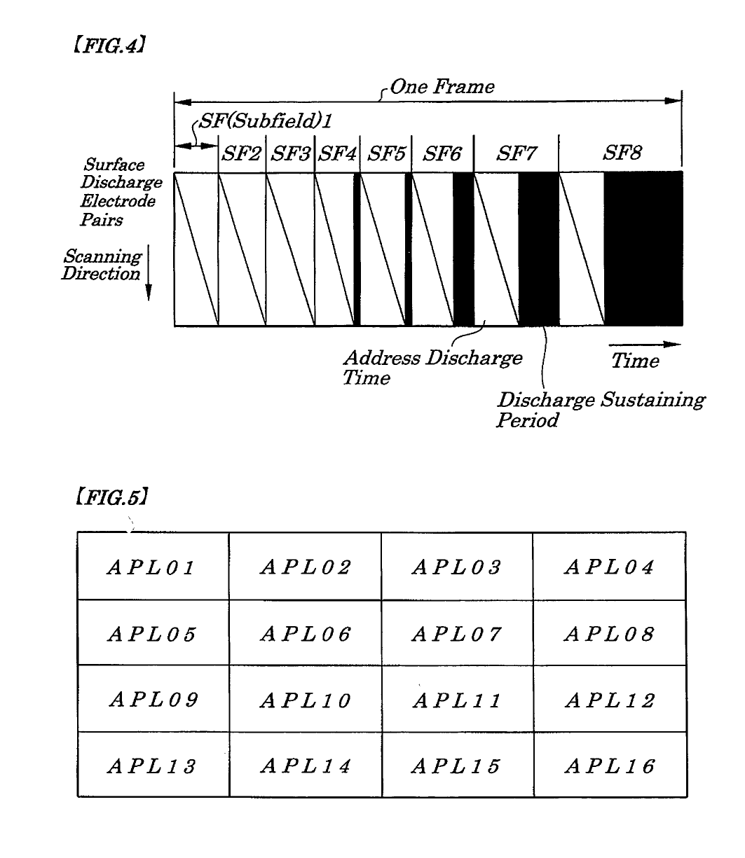

FIG. 4 is a diagram explaining a gray-level display method used in the PDP in FIG. 3 and time is plotted as ordinate and surface discharge electrodes (with no names) of the PDP as abscissa. In the PDP, as shown in FIG. 4, one frame (for example, 16.7 ms, also called as a “1TV field”) is divided into 8 subfields (SF1, SF2, . . . , SF8) and each of these subfields is still divided into an address discharge period and discharge sustaining period. Each of the oblique lines in each address discharge period indicates timing of a scanning pulse to be applied to each of the surface discharge electrode pairs. When the scanning pulse and display data pulse to be applied to the data electrode are applied simultaneously, a writing discharge occurs. The shaded portion in FIG. 4 (that is, discharge sustaining period) is a period during which a display cell emits light for displaying. During the discharge sustaining period, a discharge sustaining pulse is applied to the surface discharge electrode 12. The display cell in which discharge occurs during the address discharge period emits light with the strength corresponding to the length of the discharge sustaining period. The length of the 8 discharge sustaining periods in FIG. 4 is set at a ratio of 1:2:4:8:16:32:64:128 and, therefore, by combining light-emission during the discharge sustaining period, screens with 256 gray levels (0-255) are displayed. Moreover, light-emission luminance in the subfields is determined by the number of times of discharge sustaining pulses during the discharge sustaining period. As a frequency of the discharge sustaining pulse during the discharge sustaining period becomes high, the number of times of light-emission, as a whole, increases and light-emission luminance becomes high.

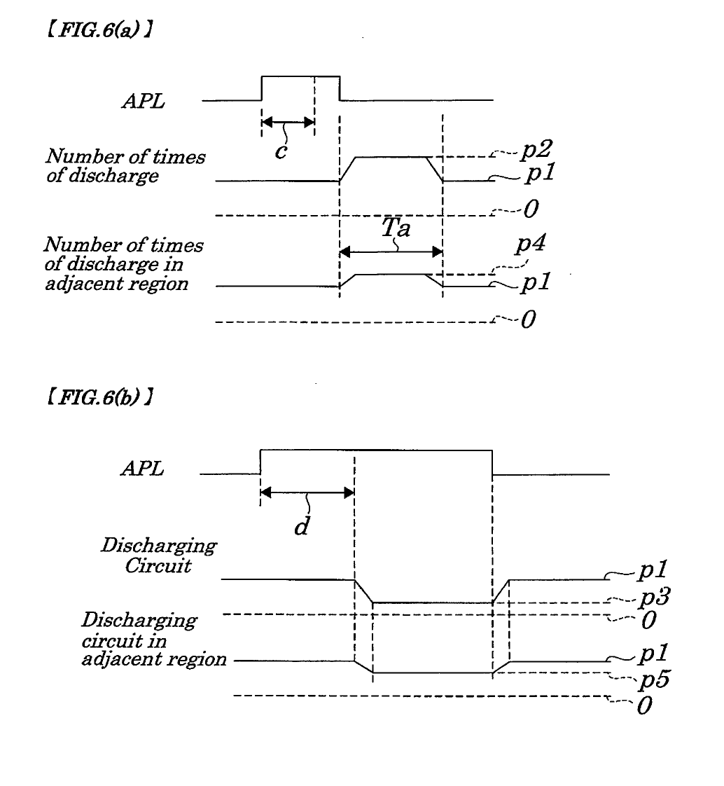

FIG. 5 is a schematic diagram showing a state in which a display screen of the display section is divided into a plurality of regions and FIG. 6 is a time chart explaining operations of the luminance control section 4. By referring to FIGS. 5 and 6, process contents for driving method to be use in the plasma display device of the embodiment are described. The APL in FIG. 6, a period during which the change of APL is smaller than designated is defined as a “High level” period and a period during which the change of APL is larger than designated is defined as a “Low level” period. The magnitude of the number of times of discharge is shown by a height of a line. In the plasma display device of the embodiment of the present invention, on the display screen of the PDP of the display section 5, when the termination of the first fixed display is detected in which the continuous time of an image is longer than the first time and is shorter than the second time being longer than the first time, since the first afterimage reduction driving mode is employed, the second driving power being larger than the first driving power, which corresponds to the normal display mode is supplied to the PDP for driving display and, when the termination of the first fixed display is detected during which the continuous time is longer than the second time, since the second afterimage reduction driving mode is used, the third driving power being smaller than the first driving power is supplied to the PDP to drive display following the termination of the first fixed display.

That is, in the APL computing section, as shown in FIG. 5, based on the image signal pi, the display screen is divided into a plurality of regions (APL01-APL16) and the APL (APLR01 to APLR16., APLG01 to APLG16, APLB01 to APLD16) (hereafter, referred to as “APLN”) of R (red), G (green), and B (blue) is computed for every specific region. In the afterimage judging section 2, APLN of R, G, and B in each region computed by the APL computing section is sent out to the memory 3 and, when the termination of the first fixed display is detected which has the continuous time (for example, the number of times of detection APLCN) during which the change of at least one APLN of R, G, and B is smaller than designated (that is, □APLN—previous APLN □□b) and the APLN is slightly larger than designated (that is, APLN□a) being longer than the first time (for example, the number of times of detection C=6) and being shorter than the second time (for example, the number of times of detection d=60) being longer than the first time, a control signal ma of the first mode is transmitted to the luminance control section 4 and when the second fixed display is detected in which the continuous time is longer than the second time (the number of times of detection d=60), the control signal mb of the second mode is transmitted to the luminance control section.

In the luminance control section 4, when the first mode control signal ma is sent out from the afterimage judging section 2, the display section 5 is driven by the operation in the first afterimage reduction driving mode and, when the second mode control signal mb is sent out from the afterimage judging section 2, the display section 5 is driven by the operation in the afterimage reduction driving mode. That is, as shown in FIG. 6(a), at the start time of the first afterimage reduction driving mode, the number of times of discharge per unit time of the discharge sustaining pulse is made by the luminance control section 4 to correspond to the first driving power p1, then gradually to the second driving power p2 and, at its termination time after a specified time Ta, the number of times of discharge is made to correspond to the second driving power p2, then gradually to the first driving power p1. Moreover, the region detected as the first fixed display is driven in the third afterimage reduction driving mode. At the start time of the afterimage reduction driving mode, power to be supplied to the region by the luminance control section 4 changes from the first driving power p1 gradually to the fourth driving power p4 and, at its termination time, the power changes from the fourth driving power p4 gradually to the first driving power p1.

Further, as shown in FIG. 6(b), at the start time of the second afterimage reduction driving mode, the number of times of discharge per unit time of the discharge sustaining pulse is made by the luminance control section 4 to correspond to the first driving power p1, then gradually to the third driving power p3 and, while the second mode control signal mb is continuously transmitted from the afterimage judging section 2, the driving power p3 continues to be applied. After the termination time of the second fixed display, when the second mode control signal mb is not further transmitted from the afterimage judging section 2, the number of times of discharge is made to correspond to the third driving power p3, then gradually to the first driving power p1. Moreover, the luminance control section 4 still provides the fourth afterimage reduction driving mode in which the fifth driving power p5 being smaller than the first driving power p1 and larger than the third driving power p3 is supplied to a region adjacent to the region detected as the second fixed display. At the start time of the fourth afterimage reduction driving mode, the power to be supplied to the region changes from the first driving power p1 gradually to the fifth driving power p5 and, at its termination time, the power changes from the fifth driving power p5 gradually to the first driving power p1.

Thus, according to the first embodiment of the present invention, on the display screen of the PDP of the display section 5, when the first fixed display is detected, by the operation in the first afterimage reduction driving mode, the second driving power p2 being larger than the first driving power p1 corresponding to the normal display mode is supplied to the PDP and, therefore, the discharge space is further activated and, as a result, the reduction of afterimages is performed in a short time, whereas, while the second fixed display is detected, by the operation of the second driving afterimage reduction driving mode, the third driving power p3 being smaller than the first driving power p1 is supplied to the PDP. Therefore, the deterioration of fluorescent substance of the display device 4 is suppressed.

Also, at the start time of the first afterimage reduction driving mode, the number of times of discharge corresponds to the first driving power p1, then gradually to the second driving power p2 and, at its termination time, the number of times of discharge corresponds to the second driving power p2, then gradually to the first driving power p1 and, therefore, rapid change in luminance is suppressed. Moreover, at the start time of the third afterimage reduction driving mode, power to be supplied to the region changes from the first driving power p1 gradually to the fourth driving power p4 and, at its termination time, the power changes from the fourth driving power p4 gradually to the first driving power p1 and, therefore, the rapid change in luminance is also suppressed. At the start time of the second afterimage reduction driving mode, by the luminance control section 4, the number of times of discharge per unit time of a discharge sustaining pulse corresponds to the first driving power p1, then gradually to the third driving power and, at its termination time, the number of times of discharge corresponds to the third driving power p3, then gradually to the first driving power p1 and, therefore, the rapid change in luminance is suppressed as well. Moreover, at the start time of the fourth afterimage reduction driving mode, the power to be supplied to the region changes from the first driving power p1 gradually to the fifth driving power p5 and, at its termination time, the power changes from the fifth driving power p5 gradually to the first driving power p1 and, therefore, the rapid change in luminance is suppressed.

In the above first embodiment, when the change in the APL for every R, G, and B in the display region is not larger than a specific value, the display is judged as a “fixed display”, however, the method of detecting the fixed display for every R, G, and B is not limited to the method using the changes in APL.

### SECOND EMBODIMENT

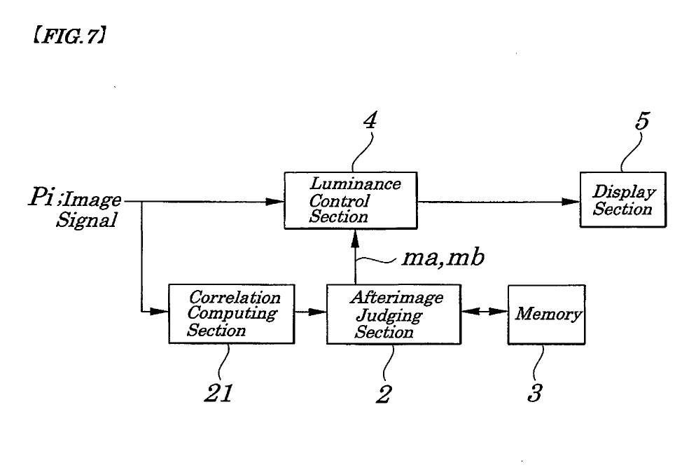

FIG. 7 is a block diagram showing electrical configurations of main components of a plasma display device according to a second example of the present invention. In the plasma display device of the second embodiment, as shown in FIG. 7, instead of the APL computing section 1 in FIG. 2, a correlation computing section 21 is included. The correlation computing section 21 computes correlation among R, G, and B in the display region based on an image signal pi. Other components than this are the same as those in FIG. 2. In the plasma display device of the second embodiment, an image signal pi is detected for every specific time or for every specific number of frames by the correlation computing section 21 and comparison is made between the image signal pi detected last time and the image signal detected this time to calculate the correlation among the R, G, and B and, if a correlation not smaller than a specific value continues, the present image is judged as fixed display by an afterimage judging section 21.

### THIRD EMBODIMENT

In the above first and second embodiments, if the first fixed display is detected in which continuous time of images having correlation not smaller than specified is longer than the first time and is not longer than the second time, the second driving power is supplied, however, even if the image corresponds to the first fixed display, there are two cases, one case having a large correlation and another case having a small correlation of images. That is, there are two cases, one case is that large part of the image shows fixed display and another case is that only one part of the image shows fixed display. Therefore, in the case where the correlation is large, control is exerted so that the second driving power becomes large driving power, while, in the case where the correlation is small, the control is exerted so that the second driving power becomes small driving power. As a result, the afterimage is effectively reduced.

It is apparent that the present invention is not limited to the above embodiments but may be changed and modified without departing from the scope and spirit of the invention. For example, the luminance control section 4 employed in the first embodiment may also be so configured that the first mode control signal ma and second control signal mb are inputted by a user's operation of a switch. In this case, an afterimage is reduced by the user's operation of the switch and simultaneously by the user's visual inspection. Moreover, instead of the APL computing section 1, a motion vector detecting section may be provided by which a motion vector in every region is obtained and, when the obtained value is not larger than specified, whether an image is first or second fixed display is judged based on continuous time of the state. Thus, the APL computing method and motion vector detecting method may be, in a wide sense, used as a method of detecting an image having a correlation being not smaller than specified to be displayed in a display screen.

1. A plasma display device comprising:
a plasma display panel;
an afterimage judging section to measure continuous time of images having correlation being not smaller than specified to be displayed on a display screen of said plasma display panel; and
a driving unit having a first afterimage reduction driving mode to drive display following termination of said first fixed display, when termination of first fixed display is detected in which said continuous time of images is longer than first time and is shorter than second time being longer than said first time, by supplying second driving power being larger than first driving power corresponding to a normal display mode to said plasma display panel.

2. The plasma display device according to claim 1, wherein said driving unit, when second fixed display is detected in which said continuous time of images is longer than said second time, to drive, based on a second afterimage reduction driving mode, said second fixed display by supplying third driving power being smaller than said first driving power to said plasma display panel.

3. The plasma display device according to claim 2, wherein said plasma display panel has a plurality of surface discharge electrode pairs, each made up of a scanning electrode and discharge sustaining electrode and disposed in parallel to each other with a discharge gap interposed, a plurality of data electrodes intersecting each of said surface discharge electrode pairs, and a plurality of display cells each formed at the intersection between the surface discharge electrode and data electrode,
wherein said driving unit line-sequentially applies scanning pluses to each scanning electrode during a period of time of one frame of said display screen to be displayed by said plurality of display cells and sets one or more address discharge periods to allow said display cell selected by applying a display data pulse being synchronous with said scanning pulse to said each data electrode to generate address discharge and one or more discharge sustaining period to allow each said display cell to emit light by applying discharge sustaining pulses to each discharge sustaining electrode and each scanning electrode, and, in said first afterimage reduction driving mode, makes number of times of discharge per unit time of said discharge sustaining pulse correspond to said second driving power, while, in said second afterimage reduction driving mode, makes number of times of discharge per unit time of said discharge sustaining pulse correspond to said third driving power.

4. The plasma display device according to claim 3, wherein said driving unit makes, at start time of said first afterimage reduction driving mode, number of times of discharge per unit time of said discharge pulse correspond to said first driving power, then gradually to said second driving power and, at its termination time, makes number of times of discharge to correspond to said second driving power, then gradually to said first driving power, and makes, at start time of said second afterimage reduction driving mode, number of times of discharge correspond to said first driving power, then gradually to said third driving power and, at its termination time, makes said number of times of discharge correspond to said third driving power, then gradually to said first driving power.

5. The plasma display device according to claim 2, wherein said driving unit divides said display screen into a plurality of regions and detects said first fixed display in every region and applies driving in said first afterimage reduction driving mode to regions where said first fixed display is detected and detects said second fixed display and applies driving in said second afterimage reduction driving mode to regions where said second fixed display is detected.

6. A plasma display device comprising:
a plasma display panel providing a plurality of display colors;
an afterimage judging section to divide a display screen of said plasma display panel into a plurality of regions and to detect correlation of a display image signal corresponding to each display color to be displayed in each of said regions and to measure continuous time of display in each of said regions having correlation being larger than specified to at least any one of display colors; and
a driving unit having a first afterimage reduction driving mode to drive display following termination of said first fixed display, when termination of first fixed display is detected in which said continuous time of an image is longer than first time and is shorter than second time being longer than said first time, by supplying second driving power being larger than first driving power corresponding to a normal display mode to said plasma display panel.

7. The plasma display device according to claim 6, wherein said driving unit having a third afterimage reduction driving mode to supply, a fourth driving power being larger than said first driving power and being smaller than said second driving power to a region adjacent to said regions driven by said second driving power.

8. The plasma display device according to claim 6, wherein control is exerted, when termination of said first fixed display is detected, so that, said second driving power, when said correlation is A, becomes larger compared with a case where said correlation is B being smaller than A.

9. The method of driving a plasma display device comprising;
a step of measuring continuous time of images having correlation being larger than specified to be displayed on a display screen of a plasma display panel; and
a step of driving display following termination of said fixed display, when second fixed display is detected in which said continuous time of an image is longer than said second time, by supplying second driving power being larger than first driving power corresponding to a normal display mode to said plasma display panel.

10. The method of driving a plasma display device comprising:
a step of detecting correlation of a display screen signal corresponding to each display color to be displayed in each region obtained by dividing a display screen of a plasma display panel into a plurality of regions;
a step of measuring an average signal level of said display image signal; and
a step of driving display in each region following the termination of said first fixed display by applying second driving power being larger than first driving power corresponding to a normal display mode when second fixed display is detected in which said continuous time of any one of display colors is longer than said second time and when an average signal level of said display colors is more than specified value.

11. The plasma display device according to claim 3, wherein said driving unit divides said display screen into a plurality of regions and detects said first fixed display in every region and applies driving in said first afterimage reduction driving mode to regions where said first fixed display is detected and detects said second fixed display and applies driving in said second afterimage reduction driving mode to regions where said second fixed display is detected.

12. The plasma display device according to claim 4, wherein said driving unit divides said display screen into a plurality of regions and detects said first fixed display in every region and applies driving in said first afterimage reduction driving mode to regions where said first fixed display is detected and detects said second fixed display and applies driving in said second afterimage reduction driving mode to regions where said second fixed display is detected.

13. The plasma display device according to claim 7, wherein control is exerted, when termination of said first fixed display is detected, so that, said second driving power, when said correlation is A, becomes larger compared with a case where said correlation is B being smaller than A.
